(19) United States
(12) Patent Application Publication
(10) Pub. No.: US 2004/0078646 A1
(43) Pub. Date: Apr. 22, 2004

(54) Recovery processing of a faulty block in a memory unit

(75) Inventor: Tadaaki Miyata, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/388,740

(22) Filed: Mar. 17, 2003

(30) Foreign Application Priority Data
Mar. 27, 2002 (JP) 2002-088441

(51) Int. Cl. G06F 11/00

(52) U.S. Cl. 714/6

(57) ABSTRACT

When a normal block of the recovery copy target having the same address as the recovery copy source is readable and the information items relating to both files using the related blocks coincide with each other, after the replacement processing of the faulty block of the recovery copy source, the block of the recovery copy source is allowed to be recovered by using the content of the block of the recovery copy target. This makes it possible that the faulty block be allowed to be recovered without the recovery copy processing being suspended.

### BACKGROUND OF THE INVENTION

1. Field of the Invention

The present invention relates to a method of recovery processing of a faulty block in a memory unit and, particularly, to a method of recovery processing of a faulty block in which, when a faulty block occurs in the memory unit of a recovery copy source during recovery copy, the faulty block can be recovered without the recovery copy processing being suspend.

2. Description of the Related Art

Conventionally, in a dual memory unit, when a faulty block occurs in the memory unit of a currently used system (0-system) and it has been impossible to write/read data into/from the faulty block, the operation is switched to the memory unit of the spare system (1-system) and thereafter, the recovering of the faulty block of the 0-system memory unit is performed. Here, it is assumed that files such as programs and data and the like are allowed to be written into at least one or more blocks and then read out of those block or blocks.

As a method of recovery processing of the faulty block described above, the following method is known. First, in order to replace the faulty block of the 0-system memory unit, an unused block located in the same 0-system memory unit is created as the alternative block. Then, a file, which should have been written into the faulty block, is allowed to be written into the alternative block. Here, since data is written into the memory units of both 0-system and 1-system at the same time in normal operation, the file which should have been written into the faulty block of the 0-system memory unit have been also written into the 1-system memory unit.

Accordingly, the files stored in all the blocks of the normal 1-system memory unit may be copied on all the blocks of the 0-system memory unit (which is indicated as a recovery copy), thereby allowing the data of both of the 0/1 systems to coincided with each other and thus the recovery processing of the faulty block to be completed.

Here, it is necessary to consider also a recovery processing method for the case where a new faulty block occurs in the memory unit of the recovery copy source (1-system) during recovery copy.

As a recovery processing for a faulty block having occurred in the memory unit of the recovery copy source, the conventional practice adopts a method in which rereading is carried out for the faulty block of the recovery copy source from which reading has failed, and then the result of the rereading is written into the memory unit of the recovery copy target (0-system).

However, in the conventional practice described above, there is a problem that, if the rereading of the faulty block of the recovery source fails, it becomes impossible to write the file data of the recovery copy source into the recovery copy target and thus it becomes impossible to perform recovery processing.

### SUMMARY OF THE INVENTION

An object of the present invention is to provide a method of recovery processing of a faulty block in which, when a faulty block occurs in the memory unit of a recovery copy source during recovery copy, the faulty block can be recovered without the recovery copy processing being suspend.

A method of recovery processing of a faulty block of a recovery copy source, comprising:

a file information comparing step of comparing information items relating to files using both blocks of said faulty block and the corresponding block of a recovery copy target having an address corresponding to said faulty block;

a readability determining step of determining whether said corresponding block is readable or not;

a faulty block replacing step of replacing said faulty block with an alternative block located in the memory unit of said recovery copy source; and

a copying step of copying the content of said corresponding block to said alternative block when said information items relating to said faulty block and said corresponding block coincide with each other in said file information comparing step and it is determined that said corresponding block is readable in said readability determining step.

Since in this configuration, if a faulty block occurs in the memory unit of a recovery copy source, when a normal block of the recovery copy target having the same address as the recovery copy source is readable and the information items relating to both files using the related blocks coincide with each other, by using a block of the recovery copy target, the recovery copy can be continued without being suspended.

### BRIEF DESCRIPTION OF THE DRAWINGS

The above and other objects, features and advantages of the present invention will become more apparent from the following detailed description when taken in conjunction with the accompanying drawings wherein:

FIG. 1 is a block diagram for showing an example configuration of the whole of the invention;

FIG. 2 is a diagram for showing blocks (portions) on memory units in a 0-system memory unit 13A and a 1-system, memory unit; and

FIG. 3 is a flow chart for illustrating the operation of the example configuration of FIG. 1.

### DETAILED DESCRIPTION OF THE PREFERRED EMBODIMENT

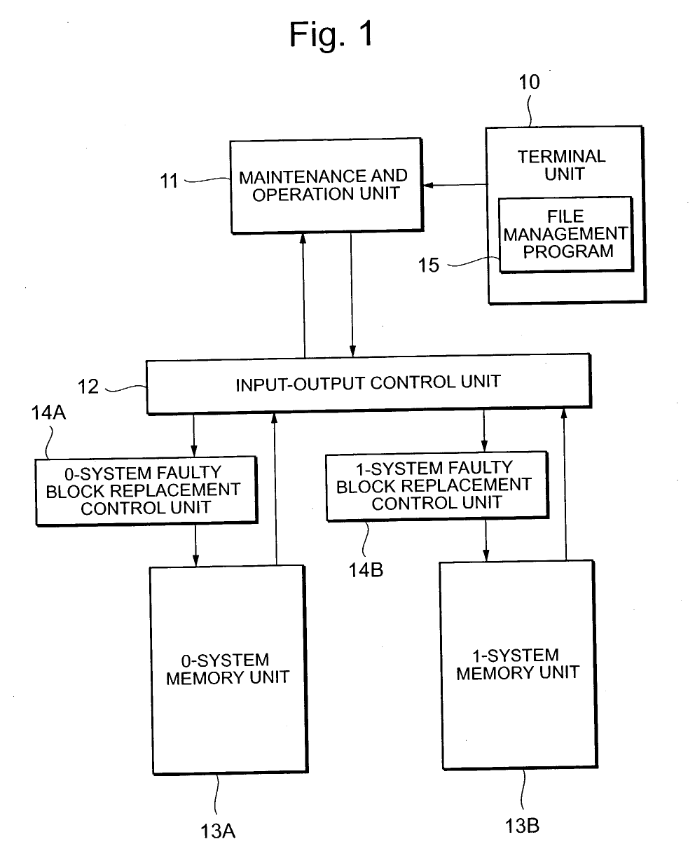

The embodiments of the invention will be described in detail, referring to FIG. 1 to FIG. 3.

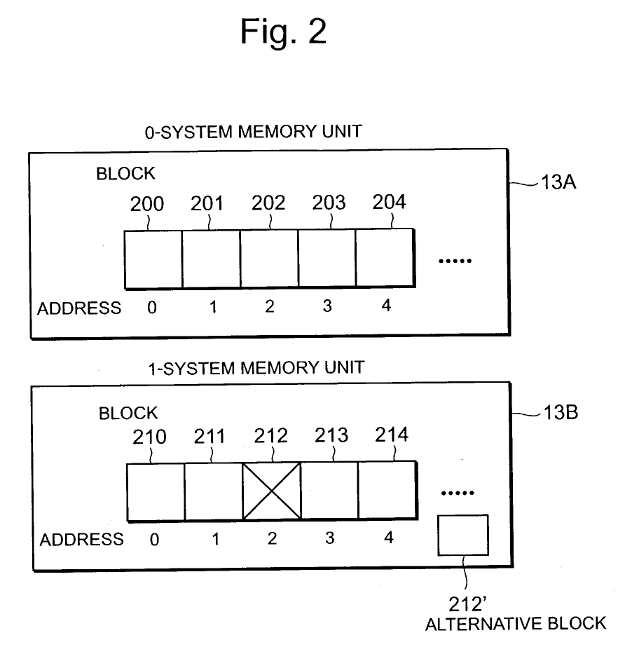

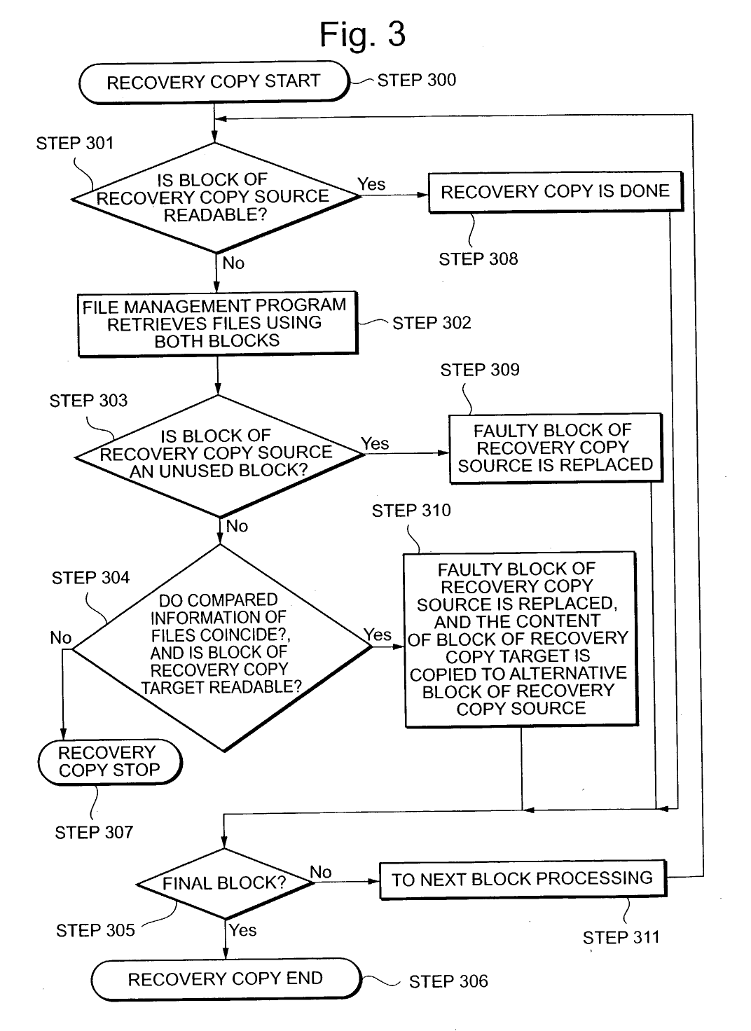

FIG. 1 is a block diagram for showing an example configuration of the whole of the invention. FIG. 2 is a diagram for showing blocks (portions) on memory units in a 0-system memory unit 13A and a 1-system memory unit 13B. Here, files such as programs, data and the like are written into at least one or more blocks, and then are read out from the block or blocks. FIG. 3 is a flow chart illustrating the operation in the example configuration of FIG. 1.

In FIG. 1, a maintenance and operation unit 11 makes an access to the dual 0-system memory unit 13A and 1-system memory unit 13B via an input-output control unit 12. This access is configured such that, in writing, writing may be performed into both the 0-system memory unit 13A and the 1-system memory unit 13B at the same time and, in reading, reading may be performed from either one system. By the way, hereinafter, the system from which reading is performed is referred to as a master.

When a faulty block occurs, a 0-system faulty block replacement control unit 14A is a unit for replacing a faulty block of the 0-system memory unit 13A with an alternative block and a 1-system faulty block replacement control unit 14B is a unit for replacing a faulty block of the 1-system memory unit 13B with an alternative block. Here, “the replacing of a faulty block with an alternative” means that an unused block located in the same 0-system memory unit is created to replace the faulty block, the unused block thus serving as an alternative block to the faulty block. Then, a file, which should be written into the faulty block, is directed to be instead written into the alternative block.

A terminal unit 10 is a terminal unit for introducing a start command at the start of recovery processing of a faulty block. Further, it is assumed that a program (which is below indicated as a file management program 15) for managing files to be written into and read from each block of the memory units 13A and 13B of both systems has been installed into the terminal unit 10.

Next, the operation of the present embodiment will described in detail, referring to FIG. 1 to FIG. 3.

In FIG. 1, it is assumed that read access is attempted from the 0-system memory unit 13A via the input-output control unit 12 using the maintenance and operation unit 11, and then the read access has ended in failure due to occurrence of a faulty block in the 0-system memory unit 13A. At this time, the maintenance and operation unit 1 detects the failure of the read access and switches the master to the 1-system memory unit 13B. Thereby, the operation comes to be performed only by the 1-system memory unit 13B.

Here, it is assumed that a command for recovery processing of the faulty block in the 0-system memory unit 13A of the recovery copy target (indicated simply as a recovery copy target) by using a normal block of the 1-system memory unit 13B of a recovery copy source (indicated simply as an recovery source below) has been sent from the terminal unit 10.

The 0-system faulty-block replacement unit 14A, which has received the above recovery processing command via the maintenance and operation unit 11 and the input-output control unit 12, replaces the faulty block of the 0-system memory unit 13A with an alternative block. Subsequently, the copying (recovery copy) of all blocks from the 1-system memory unit 13B to the 0-system memory unit 13A is started (step 300 in FIG. 3). In the recovery copy, the contents of blocks 210, 211, 212 . . . in the 1-system memory unit 13B shown in FIG. 2 are sequentially copied to the blocks 200, 201, 202 . . . having the same address in the 0-system memory unit 13A (cycle of step 301→308→305→311).

By the way, the operation described up to here is the same as that of a conventional dual memory unit.

Here, it is assumed that during the above recovery copy, the block 212 of the recovery copy source had become a faulty block and thus the contents of block 212 could not be read (step 301 in FIG. 3). At this time, the file management program 15 attempting to retrieve files using the block 212 of the recovery copy source, which could not be read on the error, and reads instead the block 202 of the same address of the recovery copy target (step 302).

From this retrieve and the “contents” of the block 202, if it is determined that the block 212 of the recovery copy source was an unused block having nothing written (Yes in the step 303 of FIG. 3) by the file management program 15, then the block 212, a faulty block, of the recovery copy source is replaced with an alternative block located in the 1-system memory unit (step 309), and then processing moves to the recovery copy processing for the next block (step 305, 311).

On the other hand, if it is determined from the contents of block 202, that the block 212 of the recovery copy source has a content written, or to be in use (No in step 303) by the file management program 15, then the file management program 15 further decides if these blocks are from the same file by comparing the file-related information items, such as a file name and time stamp, of the files of both of recovery copy source/recovery copy target using the related blocks 212,202 (step 304).

Here, if a discrepancy exists between the file-related information items, this means that the files including the related blocks 212, 202 have been changed since the master was switched from the 0-system to the 1-system for operation only by the memory unit 13B and until the recovery processing command for the 0-system faulty-block is issued. Therefore, since the related blocks 212, 202 themselves might have been changed, it is not possible to utilize the content of the block 202 of the recovery copy target as the content of the faulty block 212 of the recovery copy source. Thus, since it is impossible to continue the recovery copy processing, the processing is stopped (step 307).

Also, if the file-related information items coincide with each other, since the files including the related blocks 212, 202 are not updated, the content of the block 202 of the recovery copy target is determined to be usable. Further, it is checked whether it is possible or not to read the block 202 of the recovery copy target (step 304). In the step 304, if the file-related information items coincide with each other and it is possible to read the block 202 of the recovery copy target, the faulty block 212 of the recovery copy source is replaced with an alternative block 212′ located in the 1-system memory unit, and then the content of the block 202 of the recovery copy target is copied to the alternative block 212′ of the recovery copy source (step 310). Then, the processing moves to the recovery copy processing for a next block (steps 305, 311).

Further, in the step 304, if the block 202 of the recovery copy target can not be read due to reasons such as the occurrence of a faulty block and the like, it is impossible to continue the, recovery copy processing, thus the processing being stopped (step 307).

As described hereinbefore, by using the present invention, even if the faulty block 212 occurs and becomes unreadable in the 1-system memory unit 13B of the recovery copy source during the recovery copy processing, when the file management program 15 judges the corresponding block 202 of the 0-system memory unit 13A of the recovery copy target to be available, by using the corresponding block 202, the faulty block can be recovered in the 1-system memory unit 13B of the recovery copy source and the recovery copy processing can be continued without being stopped.

By the way, although the description has been made for an example configuration including two units (0-system/1-system) of the memory units hereinbefore, the number of the memory units is not limited to this number, and two or more memory units may be multiplexed.

The present invention provides the advantages described below during recovery copy processing.

The first advantage is provided by the invention disclosed by claim 1, and is in that if a faulty block occurs in the memory unit of a recovery copy source, when a normal block of the recovery copy target having the same address as the recovery copy source is readable and the information items relating to both files using the related blocks coincide with each other, by using a block of the recovery copy target, the recovery copy can be continued without being suspended.

This reason is as follows. In the case of a dual memory unit configuration, when analyzing the content of the block of the recovery copy target having the same address as the faulty block of the recovery copy source, it is often found that the same content as the faulty block remains therein. For this reason, if it is determined that blocks of the recovery copy target are available, after replacing blocks of the recovery copy source with alternatives, it becomes possible to recover the blocks of the recovery copy source from the blocks of the recovery copy target.

Another advantage provided by the invention is that when a faulty block occurs in the memory unit of the recovery copy source, and when the faulty block is an unused block, the content is copied from a block of the recovery copy target to the block of the recovery copy source, whereby the recovery copy can be continued without being suspended and without performing processing for recovering the faulty block of the recovery copy source.

This reason is because it is only necessary to perform replacement processing for the faulty block in the memory unit of the recovery copy source since the unused block has no content written.

While this invention has been described with reference to a certain preferred embodiment, it is to be understood that the subject matter encompassed by the invention is not limited to this specific embodiment. Instead it is intended for the subject matter of the, invention to include all such alternatives, modifications and equivalents as can be included within the spirit and scope of the following claims.

What is claimed is:

1. A method of faulty block recovery processing in a dual memory unit,
the dual memory unit having a first memory system and a second memory system,
the second memory system being operated to store a duplicative copy of the information stored in the first memory system,
the method comprising the steps of:
determining through a read operation that a faulty block exists within a set of blocks in the second memory system;
executing a recovery processing command to the first memory system and to the second memory system;
creating a source alternative block within the first memory system, and creating a target alternative block within the second memory system;
determining a corresponding set of blocks of the first memory system storing duplicative information of information that should be stored in the faulty set of blocks of the second memory system;
copying the duplicative information from the first memory system from the determined corresponding blocks of the first memory system;
writing the duplicative information to equivalent addresses within the faulty set of blocks of the second memory system;
during said copy step, determining whether each block of the corresponding set of blocks is readable or not;
when a particular block of the corresponding set of blocks cannot be read, copying information from the equivalent address within the faulty set of blocks of the second memory system;
evaluating the information copied from the, equivalent address within the faulty set of blocks to determine whether the particular block was an unused block having nothing written;
when the equivalent block is determined to have been an unused block, replacing the particular block with the source alternative block;
when the equivalent block is determined not to have been an unused block, determining whether the particular block and the equivalent block are blocks from the same file by evaluating whether these two blocks have the same file-related information items if determined not to be the same file, issuing a recovery stop command; and
if determined to be the same file, reading the equivalent block from the recovery target and writing the equivalent block to the source alternative block of the source memory.

2. A method of recovery processing of a faulty block of a recovery copy source, comprising:
a file information comparing step of comparing information items relating to files using both blocks of said faulty block and the corresponding block of a recovery copy target having an address corresponding to said faulty block;
a readability determining step of determining whether said corresponding block is readable or not;
a faulty block replacing step of replacing said faulty block with an alternative block located in the memory unit of said recovery copy source; and
a copying step of copying the content of said corresponding block to said alternative block when said information items relating to said faulty block and said corresponding block coincide with each other in said file information comparing step and it is determined that said corresponding block is readable in said readability determining step.

3. The method of recovery processing of a faulty block, as claimed in claim 1, wherein:
when it is determined that said faulty block is an unused block having no content written therein in said file information comparing step, the content of said corresponding block is not copied to said alternative block in said copying step.

4. The method of recovery processing of a faulty block, as claimed in claim 1, wherein:
when said information items relating to said faulty block and said corresponding block do not coincide with each other in said file information comparing step, the recovery copy processing is suspended.
